(19) United States
(12) Patent Application Publication
(10) Pub. No.: US 2025/0205943 A1
(43) Pub. Date: Jun. 26, 2025

(54) MOLDING APPARATUS AND MOLDING METHOD

(71) Applicant: CANON KABUSHIKI KAISHA, Tokyo (JP)

(72) Inventors: DAIKI YAMAMOTO, Kanagawa (JP); YUKUO YAMAGUCHI, Tokyo (JP); RYO SATO, Kanagawa (JP); SHUICHI HASEGAWA, Kanagawa (JP); TOMOAKI KAMAGATA, Kanagawa (JP); TOSHIYUKI TOMITA, Kanagawa (JP); KAZUNORI SUZUKI, Saitama (JP); MOTOHIRO WATANABE, Saitama (JP); KAZUNORI IIMURA, Ibaraki (JP); SATOSHI KAYABA, Ibaraki (JP)

(21) Appl. No.: 18/973,335

(22) Filed: Dec. 9, 2024

(30) Foreign Application Priority Data
Dec. 21, 2023 (JP) 2023-216135

(51) Int. Cl. B29C 45/04; B29C 45/14; B29C 45/26; B29L 31/00

(52) U.S. Cl. CPC B29C 45/0441; B29C 45/14467; B29C 45/2681; B29C 2045/14524; B29L 2031/7678

(57) ABSTRACT

A molding apparatus is used, the apparatus including a mold made up of a first mold, a second mold opposite the first mold, and an intermediate mold disposed between the first mold and the second mold. The apparatus further includes a support member configured to support the intermediate mold, and an injection mechanism configured to inject molten resin. The support member includes a rotating mechanism. The intermediate mold is mounted on the rotating mechanism such as to rotate coaxially with the rotation axis of the rotating mechanism.

### BACKGROUND OF THE INVENTION

### Field of the Invention

The present invention relates to a molding apparatus and a molding method.

### Description of the Related Art

Molded parts provided by a molding process, typically injection molding, are conventionally joined by ultrasonic welding, vibration welding, hot plate welding, or laser welding, all of which fuse a weld part placed on the molded parts to bond them together. In these methods, the molded parts to be welded together are positioned relative to each other, and the weld part is melted by applying energy, while keeping the molded parts in pressure contact with each other. For the welding to be performed correctly, the molded parts are then cooled sufficiently while still in pressure contact. The weld part where stress is concentrated must be sufficiently pressed from both sides at this time. Otherwise, local deformation may occur, which may impede correct welding. Any misalignment in the positions of the molded parts relative to each other, or temperature variations during the process, may also lead to failure to achieve proper bonding strength.

Some methods adopted in recent years use molten resin to bond molded parts together to improve reliability and bonding strength, as well as to reduce equipment costs. For example, an injection molder is used to mold several one-piece parts first. The mold is then opened, and moved to position the one-piece parts opposite each other. The mold is closed again in this state to assemble the one-piece molded parts together and to create a cavity for bonding them together. Molten resin is then poured into the cavity for bonding. This method allows a single injection molder to finish the process until the bonding step. After molding, the molded parts are arranged on the mold and positioned opposite each other by moving the mold, which is expected to improve the positional accuracy, such as the relative positions of the parts and the degree of parallelity. Moreover, the clamping force of the injection molder can be efficiently used to bring the parts into pressure contact with each other.

However, the step of forming molded parts and the step of injecting molten resin cannot be performed simultaneously with the above method. European Patent No. 2542400 proposes a configuration in which a rotatable intermediate mold is provided. In this case, a molded part is first formed between one mold and a first surface of the intermediate mold, and left in the intermediate mold. The intermediate mold is then rotated 180° to move the molded part to a position between the other mold and a second surface of the intermediate mold, where another molding operation is performed using molten resin. This allows both steps to be performed simultaneously, using both surfaces of the intermediate mold, improving productivity. The intermediate mold could also be rotated by 90° to allow various different processes to be performed on the operator side of the molder or on the opposite side. The various processes can include, for example, the assembly of the parts on the mold using a feeder, the insertion of another part, or the ejection of products, for example.

### SUMMARY OF THE INVENTION

European Patent No. 2542400 discloses an injection molding apparatus having an intermediate mold disposed between and in parallel with a first mold and a second mold. The intermediate mold is mounted on a rotary unit that is rotatably supported on a support member. The rotary unit rotates the mold using a motor and gears, for example, by contact with the gears of the rotary unit.

The mold is basically required to have high mold closure accuracy. With a rotary unit driven through gears, as in European Patent No. 2542400, fluctuations in the stopping position of the intermediate mold due to the play in the gears will be an issue. Tapered guide pins and the like can be used during mold closure to correct misalignment. However, this will cause stress to be applied to the mold each time the mold is closed and could affect durability.

The present invention was made in view of the issue described above. An object of the present invention is to improve mold closure accuracy in molding apparatuses for molding parts with molten resin using a rotating intermediate mold.

The present invention provides a molding apparatus comprising:
a mold including a first mold, a second mold opposite the first mold, and an intermediate mold disposed between the first mold and the second mold;
a support member configured to support the intermediate mold; and
an injection mechanism configured to inject molten resin, wherein
the support member includes a rotating mechanism, and the intermediate mold is mounted on the rotating mechanism such as to rotate coaxially with a rotation axis of the rotating mechanism.

The present invention also provides a molding method using a molding apparatus, the molding apparatus including: a mold including a first mold, a second mold opposite the first mold, and an intermediate mold disposed between the first mold and the second mold; a support member configured to support the intermediate mold; and an injection mechanism configured to inject molten resin, wherein the support member includes a rotating mechanism, and the intermediate mold is mounted on the rotating mechanism such as to rotate coaxially with a rotation axis of the rotating mechanism,
the method comprising:
   injecting the molten resin between the first mold and the intermediate mold to obtain a first molded part;
   injecting the molten resin between the second mold and the intermediate mold to obtain a second molded part; and
   assembling the first molded part and the second molded part and bonding the first molded part and the second molded part together with the molten resin.

According to the present invention, mold closure accuracy can be improved in molding apparatuses for molding parts with molten resin using a rotating intermediate mold.

Further features of the present invention will become apparent from the following description of exemplary embodiments with reference to the attached drawings.

### BRIEF DESCRIPTION OF THE DRAWINGS

FIG. 1 is a schematic diagram of a molding apparatus, carrying thereon a 3-plate mold;

FIG. 2 is a cross-sectional view of a support member and an intermediate mold;

FIG. 3 is a transparent plan view of the support member and the intermediate mold;

FIG. 4 is a schematic perspective view of LM guides of the molding apparatus;

FIG. 5A to FIG. 5D show the procedure of placing the mold in one embodiment of the present invention;

FIG. 6 is a schematic cross-sectional view of an inkjet printer;

FIG. 7A to FIG. 7C are views illustrating the structure of a liquid storage container;

FIG. 8 is a schematic diagram of process steps of forming a connection part of the liquid storage container; and

FIG. 9A to FIG. 9C are cross-sectional views illustrating a bonding step for the connection part.

### DESCRIPTION OF THE EMBODIMENTS

A preferred embodiment of this invention will be hereinafter illustratively described in detail with reference to the drawings. It should be noted that, unless otherwise specified, the sizes, materials, shapes, and relative arrangement or the like of constituent components described in the embodiment are not intended to limit the scope of this invention. The components once described below as being of a certain material and having a certain shape should be understood to be of the same material and have the same shape in later descriptions thereof unless otherwise specifically stated. Existing or known techniques in the applicable technical field can be applied to the configurations or processes that are not illustrated or described in particular. Some repetitive descriptions may be omitted.

### Embodiment

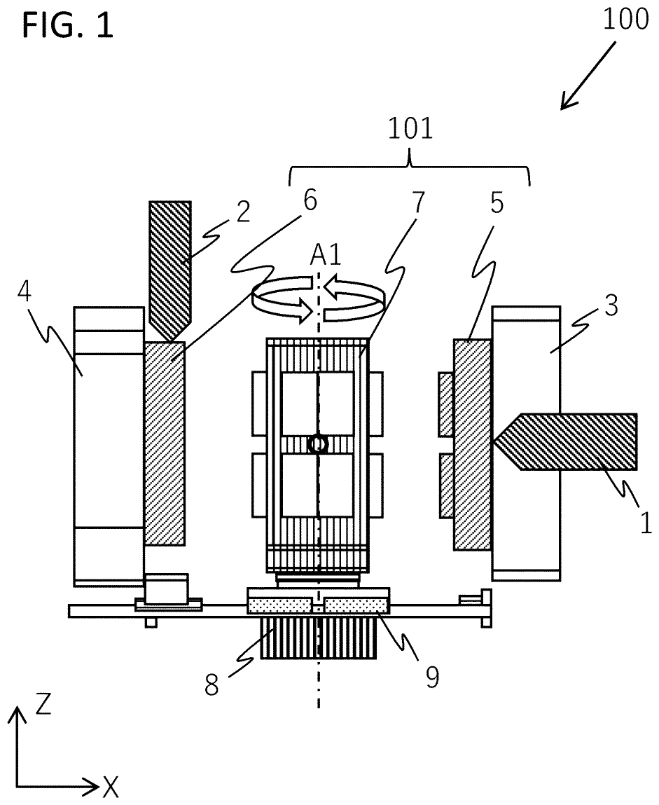

FIG. 1 is a schematic diagram of a 3-plate mold 101 including a first mold half 5 (first mold), a second mold half 6 (second mold), and an intermediate mold 7. The first mold half 5 is mounted on a first plate 3 of the molding apparatus 100. The second mold half 6 is mounted on a second plate 4 of the molding apparatus 100. The intermediate mold 7 is a rotatable member disposed between the first mold half 5 and the second mold half 6. Examples of applicable configurations include those in which the intermediate mold 7 is rotated about an axis A1 perpendicular to the mold opening/closing direction, so that primary molded parts are molded between the first mold half 5 and the intermediate mold 7, and a secondary molding operation is performed between the second mold half 6 and the intermediate mold 7 to bond the primary molded parts together with a bonding resin.

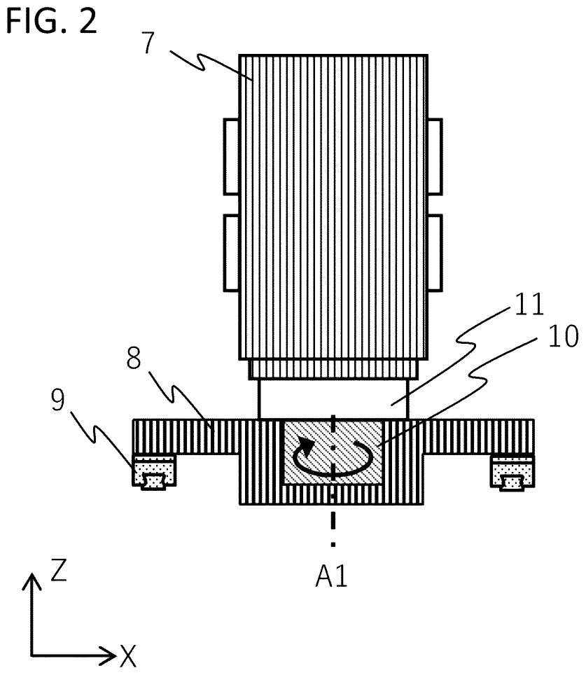

In this embodiment, as shown in the cross-sectional view of FIG. 2, the intermediate mold 7 is mounted in a rotatable manner, directly on a drive unit of a support member 8 without any movable components interposed therebetween. The drive unit is rotated by an electrically controlled direct drive motor 10, for example. The intermediate mold 7 is preferably mounted such as to rotate coaxially with a rotation axis of the mechanism for rotating the support member 8. A fastening member such as a magnet clamp 11, for example, may be used when mounting the intermediate mold 7 on the support member 8 on the molding apparatus 100. The use of the clamp allows easy mounting and dismounting of the mold 101 without causing any adverse effects on the precision during rotation. By using a direct drive motor 10 that has a hollow structure, components can be mounted to the mold through inside of the motor.

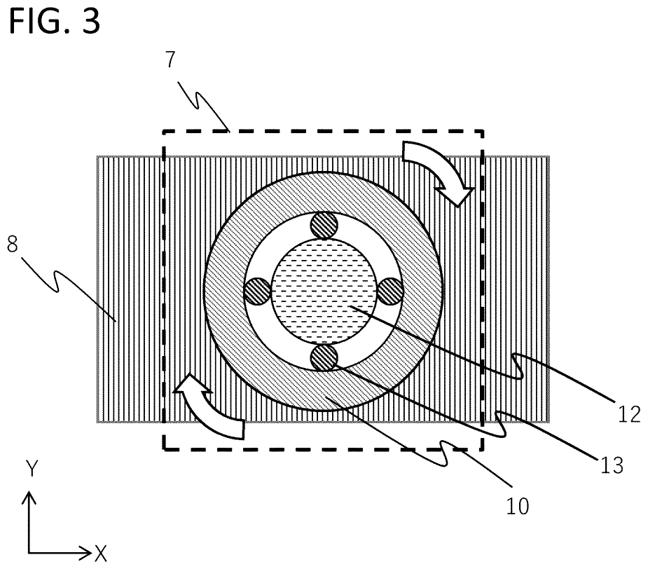

This embodiment adopts a rotary joint 12 for supply and discharge of a fluid between a stationary piping system and rotating portions, as shown in the transparent plan view of FIG. 3. Thus water can be distributed to the intermediate mold 7 for mold temperature adjustment in a compact design. The hollow part of the direct drive motor 10 can also allow passage of ejector rods 13 therethrough, which are for moving an ejector plate inside the mold when ejecting a molded part molded in the mold 101.

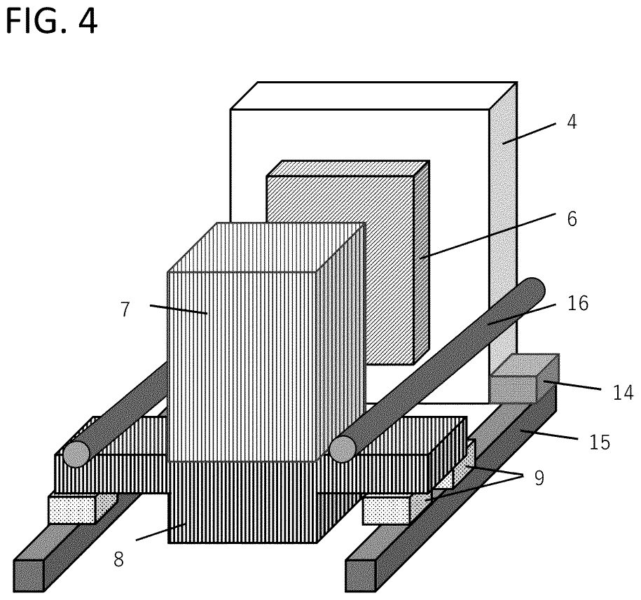

The schematic perspective view of FIG. 4 illustrates a configuration for linear movements in the molding apparatus 100. A first LM guide (linear motion guide) 9 on which the support member 8 is mounted is a movable member that moves straight along parallel guide rails 15. A second LM guide 14 on which the second plate 4 is mounted is movable along the same guide rails 15, too. Thus the second plate 4 and the intermediate mold 7 are able to move in parallel on the same track. The intermediate mold 7 and the molding apparatus 100 may be provided with independent tie bars 16 for better track reproducibility when opening and closing the mold.

The support member 8 supports the moment applied by the intermediate mold 7 on one end when the mold 101 is opened and closed, and therefore requires high rigidity. Some fixed portions are expected to receive loads such as a moment load generated when the motor rotates, a torsional moment that occurs at the start or stop, a moment generated when the mold 101 opens and closes, and concentrated stress. It is therefore necessary to select a direct drive motor 10 that satisfies the conditions for required torque and rigidity in consideration of the acceleration of the mold opening and closing operations of the molding apparatus 100, and the weight of the intermediate mold 7, taking account of safety rate. Total optimization including the rotation of the intermediate mold and the takt time for opening and closing the mold is desirable. In a conceivable configuration that allows for dispersion of stress, a different peripheral device than the support member may hold the intermediate mold 7 from above. Such a holding device disposed above can be considered one of the constituent elements of the molding apparatus. However, using such peripheral holding devices will require more space and a larger investment. Therefore, a cantilevered configuration where the mold is supported from below is recommended.

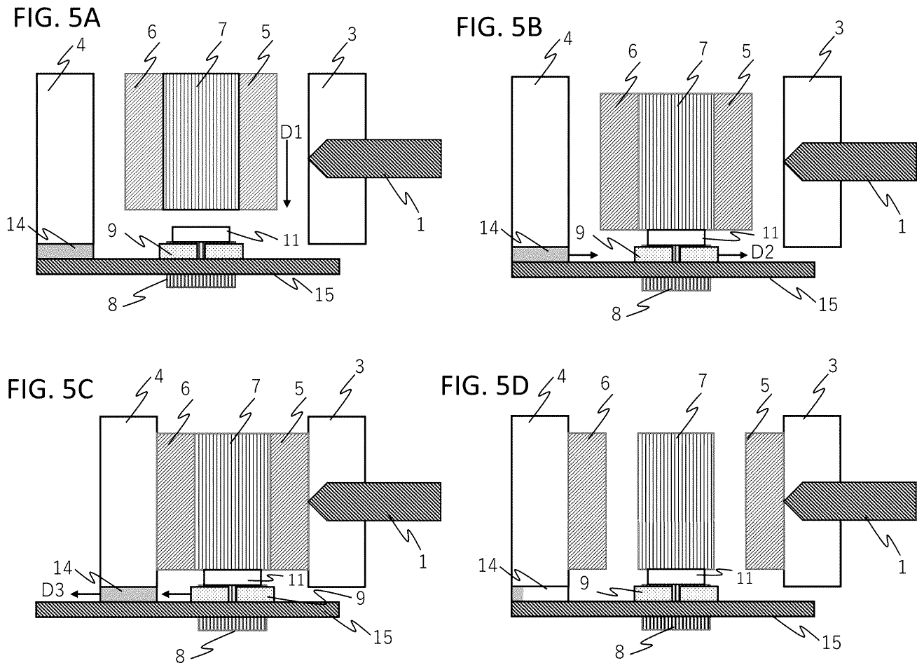

FIG. 5A to FIG. 5D show the procedure of placing the mold 101. The drawings show side views of the mold being closed and opened along the guide rails in the left and right direction of the paper plane. In these drawings, the direction perpendicular to the mold opening/closing direction is the rotation axis of the rotating mechanism and the intermediate mold 7.

To mount the intermediate mold 7 on the support member 8, first, as shown in FIG. 5A, the mold 101 is placed onto the support member 8 using a magnet clamp 11, with the first mold half 5, second mold half 6, and intermediate mold 7 being closed (arrow D1). This determines the position of the first mold half 5 and second mold half 6, with the intermediate mold 7 as the reference, which enables the first and second mold halves to be positioned relative to each other when they are closed. Next, as shown in FIG. 5B, the support member 8 and the intermediate mold 7 mounted on the first LM guide 9, and the second plate 4 mounted on the second LM guide 14, are moved in unison along the same guide rails 15 (arrow D2).

This brings the first mold half 5 and the second mold half 6 into contact with the first plate 3 and the second plate 4, respectively, as shown in FIG. 5C. Molten resin is then injected from a first injection unit 1 for a molding operation between the first mold half 5 and the intermediate mold 7 (first molding operation). Next, to open the mold, the support member 8 and the intermediate mold 7 mounted on the first LM guide 9, and the second plate 4 mounted on the second LM guide 14, are moved along the same guide rails 15 in the opposite direction from when closing the mold (arrow D3).

Thus the mold is opened as shown in FIG. 5D. Next, the intermediate mold 7 is rotated, driven by the direct drive motor 10 (rotating operation), to proceed to another molding operation between the second mold half 6 and the intermediate mold 7. The mold can be closed with the mold halves and other members kept in parallel, similarly to the above, by moving them along the guide rails 15. Molten resin is then injected from a second injection unit 2 for the molding operation between the second mold half 6 and the intermediate mold 7 (second molding operation). The mold is then opened to allow removal of the final molded product.

The first injection unit 1 and second injection unit 2, serving as an injection mechanism, need only have a function of injecting molten resin into a mold cavity. The injection mechanism need not necessarily be divided into two injection units; it may have one injection unit, or three or more. The series of process steps described above, from the placement of the mold through to the first molding operation, rotating operation, and second molding operation, may be carried out under the control of a controller (e.g., processor) of the molding apparatus 100, or a controller outside the molding apparatus 100.

### Effects

As described above, in a conventional molding apparatus that uses a 3-plate mold including an intermediate mold in addition to first and second mold halves, the rotary unit on which the intermediate mold is mounted is configured to rotate through gears being driven by a motor. This configuration has limited precision in positioning the intermediate mold, because of the fluctuations in the stopping position of the intermediate mold due to the play in the gears. In a configuration where the intermediate mold is supported via tie bars, such fluctuations in the stopping position of the intermediate mold could compromise the mold closure accuracy due to the load on the tie bars and consequent deflection, sometimes impeding correct opening and closing of the mold.

Accordingly, the present invention adopts a configuration in which the intermediate mold 7 is mounted on a rotating device for the support member 8, for use in cases where products are manufactured using a mold including the intermediate mold 7 between first and second mold halves 5 and 6 opposite each other. Namely, the intermediate mold 7 is directly mounted on the support member 8 that is equipped with a direct drive motor. Preferably, the intermediate mold 7 is configured to rotate coaxially with a rotation axis of the rotating device provided to the support member 8. This obviates the need to interpose components such as gears, which may compromise the positioning precision, to the mechanism associated with rotation of the intermediate mold 7, so that the stopping position of the intermediate mold 7 is made consistent. As a result, the mold closure accuracy can be improved. Improved mold closure accuracy reduces loads applied on the mold and the molding apparatus, which contributes to higher durability. In addition, as there is no need to provide actuators required for driving gears separately from the rotating portions, the support member can be made more compact.

The support member is mounted on the same guide rails as the first mold half and second mold half, and positioned relative to the intermediate mold as the reference. The first mold half and second mold half are positioned relative to the intermediate mold as the reference. Thus the surfaces facing each other when the mold is closed can be kept in parallel, allowing even more accurate mold closure.

### Application Example

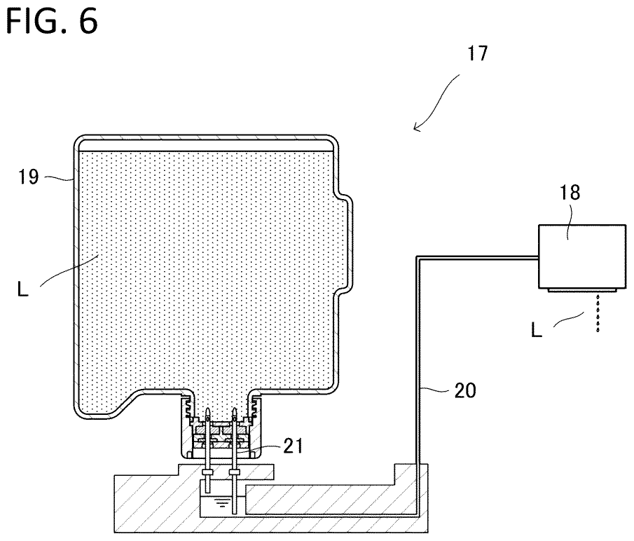

One case will be described with reference to FIG. 6 to FIG. 9A to FIG. 9C, in which liquid storage containers for inkjet printers are manufactured using an injection molding apparatus, to which the molding apparatus 100 of the present invention is applied. FIG. 6 is a cross-sectional view illustrating a schematic of an inkjet printer 17. The inkjet printer 17 includes an inkjet print head 18 configured to expel a liquid L such as ink reserved in the liquid storage container 19. The inkjet print head 18 ejects the liquid L onto a recording medium such as paper in accordance with instructions from a controller such as a computer, so that an image is recorded. The inkjet printer 17 is also called a liquid ejection apparatus or a recording apparatus, and the inkjet print head 18 is also called a liquid ejection head or a recording head.

In the inkjet printer 17, the liquid storage container 19 that holds the liquid and the inkjet print head 18 are in fluid communication with each other via a tube 20 and hollow needles 21. The molding apparatus 100 of the present invention is useful, for example, when making a connection part of the liquid storage container 19.

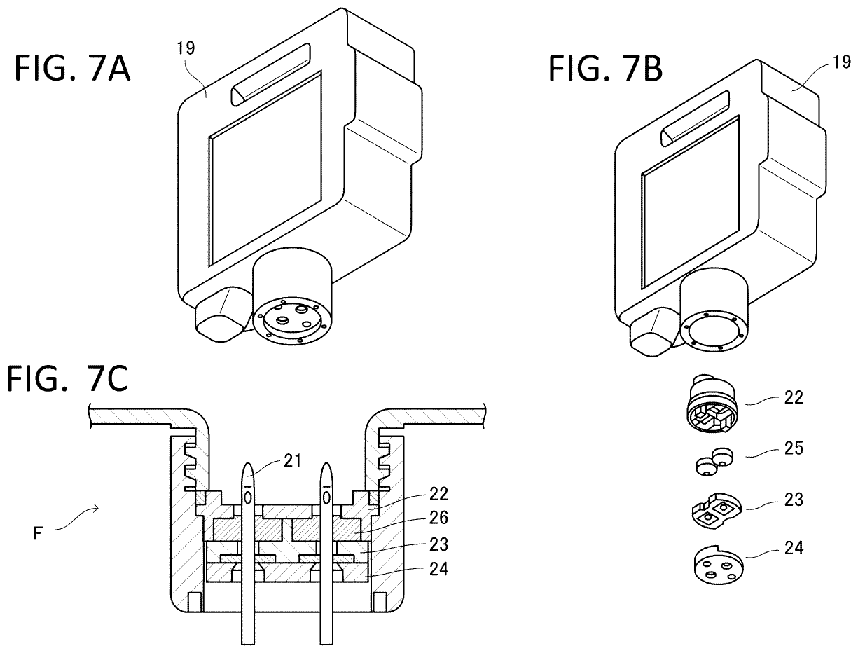

FIG. 7A is a perspective view of the liquid storage container 19, and FIG. 7B is an exploded view of the liquid storage container 19. FIG. 7C is a cross-sectional view illustrating the connection part F. As shown in FIG. 7A to FIG. 7C, the connection part has a first molded part 22, a second molded part 23, and a third molded part 24, arranged in such a manner that a cavity part 26 is formed. Inside the molded parts assembled together is disposed an elastic member 25 with notches 28 for allowing insertion of the hollow needles 21. The connection part F, with this configuration, provides the function of a valve, for holding and supplying the liquid.

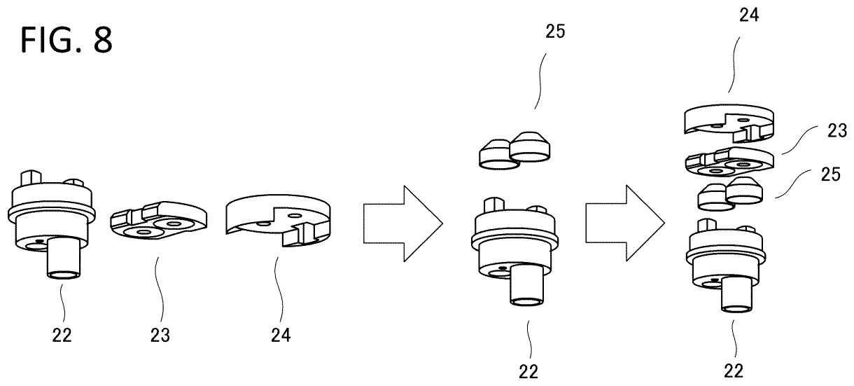

FIG. 8 is a cross-sectional view illustrating the process steps of forming the connection part F. First, the first molded part 22, second molded part 23, and third molded part 24 are formed by injection molding. Next, the elastic member 25 is placed on the first molded part 22. Lastly, the second molded part 23 and third molded part 24 are assembled on, and bonded to, the first molded part.

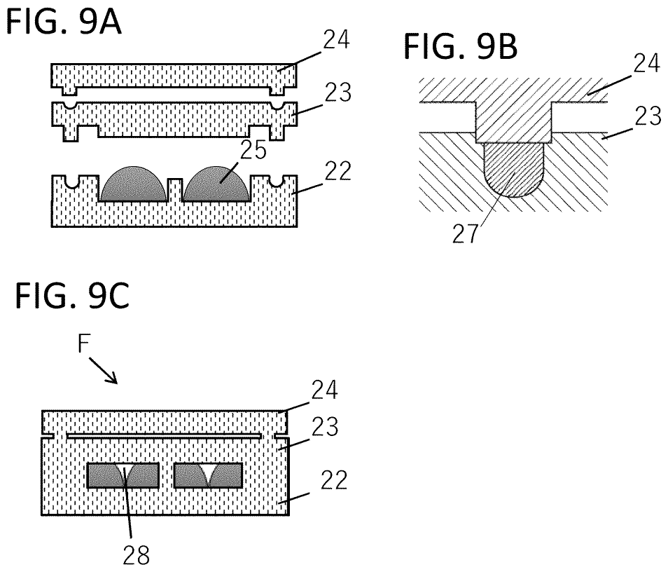

FIG. 9A to FIG. 9C are cross-sectional views illustrating the bonding step during the formation of the connection part F. As shown in FIG. 9A, after assembling the first to third molded parts 22 to 24 together, molten resin is poured into the cavity part to make a one-piece molded product. For example, in FIG. 9B, the molten resin 27 is poured into the cavity between a recessed portion of the second molded part 23 and a protruded portion of the third molded part 24. Thus a connection part F such as the one shown in FIG. 9C is formed. The notches 28 formed in the elastic member 25 in advance widen as shown in the drawing by the pressure applied at this time, so that the hollow needles 21 can readily be inserted.

In the injection molding apparatus according to the present invention, each part is molded using the first mold half 5 and the intermediate mold 7 as the first process step. After that, the elastic member 25 is supplied to the first molded part 22, and the second molded part 23 and third molded part 24 are ejected and assembled onto the elastic member 25, in the second process step.

In the third process step, a bonding operation is performed to the assembly of the molded parts and the elastic member that were assembled together in the second process step. The molded parts are set between the second mold half 6 and the intermediate mold 7 such that a cavity part is formed between the molded parts, and the molten resin 27 is poured into this cavity part. The elastic member 25 compressed by the mold clamping force causes the molded parts to make desirable pressure contact with each other, enabling stable hold of the molded parts during the injection, and until cooling, of the molten resin 27. Since the mold halves in this embodiment are positioned relative to the intermediate mold 7 as the reference, misalignment of the molded parts in pressure contact with each other can be prevented. Lastly, in the fourth process step, the finished one-piece molded product is ejected and removed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-216135, filed on Dec. 21, 2023, which is hereby incorporated by reference wherein in its entirety.

What is claimed is:

1. A molding apparatus comprising:
a mold including a first mold, a second mold opposite the first mold, and an intermediate mold disposed between the first mold and the second mold;
a support member configured to support the intermediate mold; and
an injection mechanism configured to inject molten resin, wherein
the support member includes a rotating mechanism, and the intermediate mold is mounted on the rotating mechanism such as to rotate coaxially with a rotation axis of the rotating mechanism.

2. The molding apparatus according to claim 1, wherein a first molding operation is performed in which the molten resin is injected between the first mold and the intermediate mold, and a second molding operation is performed in which the molten resin is injected between the second mold and the intermediate mold, after the intermediate mold has been rotated by the rotating mechanism after the first molding operation.

3. The molding apparatus according to claim 1, further comprising a guide rail on which the first mold and the second mold are mounted such as to open and close, wherein
the support member on which the intermediate mold is mounted is mounted on the guide rail between the first mold and the second mold, and
the intermediate mold is configured to be rotated by the rotating mechanism when the first mold and the second mold are opened.

4. The molding apparatus according to claim 1, wherein the intermediate mold is configured to rotate about an axis perpendicular to an opening/closing direction of the first mold and the second mold.

5. The molding apparatus according to claim 4, wherein the intermediate mold is configured to move in the opening/closing direction, in coordination with the first mold and the second mold.

6. The molding apparatus according to claim 1, wherein the intermediate mold is supported from below by the support member.

7. The molding apparatus according to claim 1, wherein the intermediate mold is supported from above by a holding mechanism different from the support member.

8. The molding apparatus according to claim 1, wherein the rotating mechanism provided to the support member includes a hollow part to allow a component to be attached to the intermediate mold through the hollow part.

9. A molding method using a molding apparatus, the molding apparatus including: a mold including a first mold, a second mold opposite the first mold, and an intermediate mold disposed between the first mold and the second mold; a support member configured to support the intermediate mold; and an injection mechanism configured to inject molten resin, wherein the support member includes a rotating mechanism, and the intermediate mold is mounted on the rotating mechanism such as to rotate coaxially with a rotation axis of the rotating mechanism,
the method comprising:
injecting the molten resin between the first mold and the intermediate mold to obtain a first molded part;
injecting the molten resin between the second mold and the intermediate mold to obtain a second molded part; and
assembling the first molded part and the second molded part and bonding the first molded part and the second molded part together with the molten resin.

10. The molding method according to claim 9, wherein a liquid storage container for an inkjet printer is molded with the molten resin.
